(19) United States
(12) Patent Application Publication
(10) Pub. No.: US 2005/0146875 A1
(43) Pub. Date: Jul. 7, 2005

(54) Side-emitting led marine signaling device

(75) Inventor: W. Richard Klein, Houston, TX (US)

Correspondence Address: FULBRIGHT & JAWORSKI, LLP, 1301 MCKINNEY, SUITE 5100, HOUSTON, TX, 77010-3095, US

(73) Assignee: TIDELAND SIGNAL CORPORATION

(21) Appl. No.: 10/752,765

(22) Filed: Jan. 7, 2004

(51) Int. Cl. F21V 33/00

(52) U.S. Cl. 362/253

(57) ABSTRACT

The present invention is directed to a signaling device that incorporates a side-emitting light emitting diode (LED), a first optic, which partially deviates and focuses the radiated light, and a second optic, which centers the beam on the horizon and determines the final vertical divergence. The means for powering the device is either a self-contained photovoltaic system or an external battery supply. The means for controlling the device is electronic circuitry.

### BACKGROUND OF THE INVENTION

The present invention relates generally to signaling devices, and particularly to signaling devices used in marine navigation applications. Signaling devices, particularly in marine applications, are used to warn or alert vessels of various conditions, structures or the like and to otherwise serve as navigational aides. Generally, signaling devices emit light in an omni-directional manner in order to adequately signal those approaching the signaling device from any direction. Signaling lights must generate an intense beam that is substantially uniform over a wide field of illumination, especially along the horizon. For a useable marine light that is highly visible in all directions, it is necessary to manipulate emitted light to center the beam on the horizon.

Signaling devices in the past have used incandescent lamps to illuminate a broad field. Omni-directional signal lights employing incandescent lamps require lenses with very large vertical acceptance angles. Signaling devices using incandescent lamps typically utilize Fresnel lenses, which consist of multiple optical surfaces alternating with non-optical step-back surfaces. Fresnel lenses for incandescent lamps are generally relatively tall and require complex three-piece molds for manufacturing. It is customary to place the incandescent lamp filament at the focus of the lens to produce a collimated beam centered on the horizon. Incandescent lamps have a relatively short service lifetime and thus require significant maintenance. Incandescent lamps also consume a great amount of power and generate a great deal of heat.

Light Emitting Diodes (“LEDs”) have been used more recently as a light source for signaling devices. LEDs provide a longer lasting light source than incandescent lamps, thereby reducing failure rate and necessary maintenance. However, light from basic LEDs is forward directed. Producing a sufficiently bright and uniform beam of omni-directional illumination has been difficult to achieve using forward-directed LEDs. Relevant past designs have utilized arrays of basic LEDs to increase the intensity and uniformity of their illumination.

In U.S. Pat. No. 6,048,083 to McDermott, there is disclosed a signaling light created by a plurality of LED elements. As disclosed by McDermott, the intensity necessary for the signaling device is maximized through the collection of light emitted from the group of LEDs. However, McDermott suffers the disadvantage that such grouped LEDs require a Fresnel optic to optimize the light emerging from the device, and such Fresnel lenses require complex, expensively manufactured three-piece molds. In U.S. Pat. No. 5,890,794 to Abtahi et al., there is disclosed a lighting unit utilizing a plurality of LED packages. The unit, however, also suffers the disadvantage of lacking an optical system to transmit light efficiently, and, instead, employs a transparent cover that does not, without modification, function to further improve the visibility of the device.

In U.S. Pat. No. 5,680,033 to Cha, there is disclosed a solar powered warning device utilizing as few as one LED to reduce the power consumption by the device. However, Cha suffers the disadvantage that the cover consists of a complex lens cover with a plurality of focusing lenses on the interior of the cover. Such a lens is complicated and expensive to manufacture. Furthermore, m a single-optical element, such as described in Cha, manufacturing constraints limit the refractive power available using common lenses. The limited refractive power thus limits the focusing power of the lens, as well as effective transmittance along the plane of the horizon.

Side-emitting LEDs are a relatively recent development in the area of LED device technology, stemming from the need for LEDs with a specific light radiation pattern. The design of a side-emitting LED is such that most of the light is emitted to the sides, over a 360-degree cone, with a cone angle of several degrees above the plane of the horizon. Very little light is transmitted in the forward direction from the side-emitting LED. A side-emitting LED incorporates a system of optics in its packaging, including a cone-shaped element of the lens encompassing the LED. One such side-emitting LED is described in U.S. Pat. No. 6,598,998 to West et al., and assigned to Lumileds Lighting, U.S., LLC., which is incorporated herein by reference. The reflective conical element on the top of a side-emitting LED directs the light out of the package roughly perpendicular to the LED package. Approximately 33% of the light emitted from the LED is reflected off the top conical element. Such a side-emitting LED emits approximately 80% of its light within about 20 degrees off a horizontal axis defined as perpendicular to the LED package.

There is a need for signaling devices using LEDs to minimize maintenance and power consumption using LEDs, while providing for maximum transmittance on the plane of the horizon using side emitting LEDs and a system of optics.

### BRIEF SUMMARY OF THE INVENTION

It is, therefore, an object of the present invention to provide a signaling device that uses LEDs to minimize maintenance and power consumption.

It is an additional object of the present invention to provide a signaling device that uses LEDs that achieve a greater transmittance of light by using materials of the most beneficial refractive power.

An additional object of this invention is to achieve concentration of light on the horizon plane by a signaling device; while at the same time providing a choice from a multiplicity of vertical beam widths and minimizing manufacturing costs.

Yet another object of the invention is to achieve a greater transmittance of light in a signaling device using an LED light source by using less expensive and more simply manufactured optics.

Still another object of this invention is to maximize transmittance of light from a side-emitting LED, such that light is transmitted substantially along the plane of the horizon.

In one aspect of the present invention, the invention is directed to a signaling device that incorporates a side-emitting LED; a first optic, which partially deviates and focuses the radiated beams from the side-emitting LED; a second optic, which centers the beams on the horizon and determines the final vertical divergence; and a power source for powering the device. The power source may be selected from a variety of commonly available sources, including a self-contained photovoltaic system or an external battery supply.

In one embodiment, the signaling device includes a base, a photovoltaic top employing photocells covered by a transparent cover, and a second optic enclosing a first optic, all disposed on the base, and a power source. Within the first optic, at least one side-emitting LED is connected electrically to electronic circuitry. The photovoltaic top is connected electrically to the electronic circuitry and at least one electrolytic cell disposed inside the base. The photovoltaic top has a transparent cover to allow sunlight in, and charges the electrolytic cell to power the signaling device and the electronic circuitry that control the flashing of the signaling device. The first and second optic focus light emitted from the side-emitting LED.

In another embodiment, the signaling device includes a base, an opaque cover colored to match the side-emitting LED, and a second optic enclosing a first optic, all disposed on the base, and a power source. Within the first optic, at least one side-emitting LED is connected electrically to electronic circuitry. The first and second optic focus light emitted from the side-emitting LED. An external battery powers the signaling device and the electronic circuitry that control the flashing of the signaling device. A photovoltaic top is not necessary when an external battery is employed.

One advantage of the signaling device of the present invention can be seen by defining two axes relative to the signaling device. There is defined a vertical axis through the center of the signaling device. Also defined is a horizontal axis, which is generally perpendicular to the LED package, and thereby perpendicular to the vertical axis. The horizontal axis is parallel with the horizon generally, though it may vary incrementally with movement of the signaling device. In certain applications, the signaling device may move, such as a buoy in the waves. In such applications, the horizontal axis of the device will not always be exactly parallel with the horizon, but will be substantially parallel relative to the horizon. For most applications, the horizon and the horizontal axis of the signaling device should deviate by an angle less than half of the vertical divergence of the light emitted from the signaling device. Preferably, the side-emitting LED emits approximately 80% of emitted light within about 20 degrees of the horizontal axis, such that the light is substantially along the plane of the horizon, and more specifically, along the horizontal axis. The advantage of the described construction is that a greater intensity of light is transmitted substantially along the horizon, making the signaling device more easily visible to approaching vessels.

In another aspect, the present invention is directed to a method for focusing light in a signaling device. The method includes the first step of providing a housing for use in an outdoor environment. The housing, in one embodiment, includes a base, a side-emitting LED, a means of powering and controlling the side-emitting LED, and an optics system, which preferably includes a first and second optic. Next, the method includes the step of passing the light through the first optic and then passing the light from the first optic to the second optic. Finally, the method includes the step of focusing light from the second optic such that the light is substantially parallel to the horizon.

In yet another aspect, the present invention is directed to an optics system for use in a signaling device. The optics system comprises a side-emitting LED emitting light, a first optic disposed around the side-emitting LED, a second optic disposed around the first optic. The first optic and the second optic cooperatively focus the light emitted from the side-emitting LED along the horizon.

Another advantage of the present signaling device is that it meets all of the requirements for manufacturing by injection molding. Injection molding is a less expensive method of manufacturing lenses. Injection molding requires that the draft on optical surfaces is downward on first, interior surfaces and upward on second, exterior surfaces. With such a design, molding is achieved using two-piece molds, instead of more costly three-piece molds. Further, material shrinkage occurs during the injection molding process. In order to maintain true optical surfaces despite material shrinkage, optical parts must be less than a certain maximum thickness, affecting the feasibility of a single optical element. Injection molding limits the refractive power that can be achieved for the maximum allowable thickness, also indicating that an adequate single optical element is not feasible through injection molding. Advantageously, the compound optic of the present invention provides the advantage that multiple thin lenses, with higher refractive power, may be manufactured by injection molding, savings on costs when compared with Fresnel lenses.

The foregoing has outlined rather broadly the features and technical advantages of the present invention in order that the detailed description of the invention that follows may be better understood. Additional objects, features, and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following description taken in conjunction with the accompanying drawing, in which:

FIG. 1 is a cross sectional view of a bent focal line lighting device conventionally used, wherein a contoured optic creates a plurality of focal points to intensify the light created by a plurality of LEDs;

FIG. 2 is a cross sectional view of a lighting unit conventionally used, wherein the lighting unit requires a number of LED packages and the transparent cover is not an optic;

FIG. 3 is an exploded view of one embodiment of the present invention;

FIG. 4 is an illustrative view of a side-emitting LED package;

FIG. 5 is an illustrative view of the refractive process of the compound optic;

FIG. 6 is an illustrative view of alternative lenses in the compound optic;

FIG. 7 is an illustrative view of one embodiment of the first optic of the present invention deviating light from a green or white side-emitting LED and the vertical divergence of such light;

FIG. 8A is an illustrative view of one embodiment of the second optic of the present invention deviating light from a green or white side-emitting LED and the final vertical divergence of such light;

FIG. 8B is an illustrative view of another embodiment of the second optic of the present invention deviating light from a green or white side-emitting LED and the final vertical divergence of such light;

FIG. 8C is an illustrative view of an alternative embodiment of the second optic of the present invention deviating light from a green or white side-emitting LED and the final vertical divergence of such light;

FIG. 9 is an illustrative view of one embodiment of the first optic of the present invention deviating light from a red or yellow side-emitting LED and the vertical divergence of such light;

FIG. 10A is an illustrative view of one embodiment of the second optic of the present invention deviating light from a red or yellow side-emitting LED and the final vertical divergence of such light;

FIG. 10B is an illustrative view of another embodiment of the second optic of the present invention deviating light from a red or yellow side-emitting LED and the final vertical divergence of such light; and

FIG. 10C is an illustrative view of an alternative embodiment of the second optic of the present invention deviating light from a red or yellow side-emitting LED and the final vertical divergence of such light.

### DETAILED DESCRIPTION OF THE INVENTION

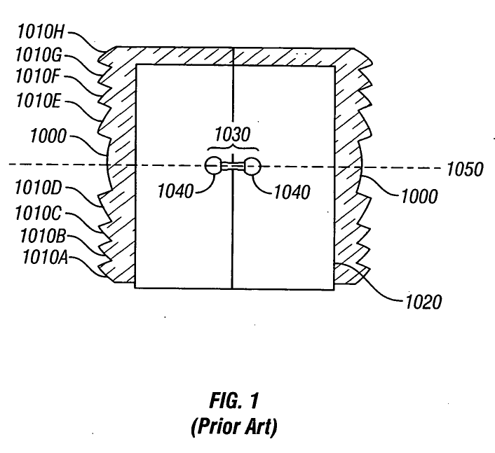

Referring to FIG. 1, a cross sectional view shows a bent focal line lighting device conventionally used. The bent focal line lighting device shown in FIG. 1 is typically used in marine applications as a navigational beacon and is described in U.S. Pat. No. 6,048,083 to McDermott. As shown in FIG. 1, a contoured optic creates a plurality of focal points to intensify the light created by a plurality of LEDs. The lighting device includes a lens with a central exterior lens surface 1000 and optical steps 1010A though 1010H, and an interior lens surface 1020. The central exterior lens surface 1000 and the optical steps 1010A through 1010H represent a typical Fresnel lens contour, substituted for a single curved exterior lens surface. The lighting device includes a lamp assembly 1030 composed of a plurality of LED devices 1040 located inward of the interior lens surface 1020. Light is emitted from the LED devices 1040 of the lamp assembly 1030, and is refracted according to the basic laws of optics at the interior lens surface 1020 and passes through the lens until it intersects the central exterior lens surface 1000 or any one of the optical steps 1010A through 1010H. At the intersection with the central exterior lens surface 1000 or any one of the optical steps 1010A through 1010H, the light is refracted along the direction of the horizon 1050 by an angle determined at the central exterior lens surface 1000 or any of the optical steps 1010A through 1010H. The light emerges from the exterior lens surface or optical step substantially parallel to the horizon 1050. The intensity of the projected light is maximized by efficient collection of created light. However, the lighting device shown in FIG. 1 suffers the disadvantage that it employs a Fresnel lens, which is complex and expensive to manufacture, particularly for large signaling devices. The lighting device of FIG. 1 suffers the additional advantage that it requires a plurality of LEDs to generate adequate light for use as a signaling device.

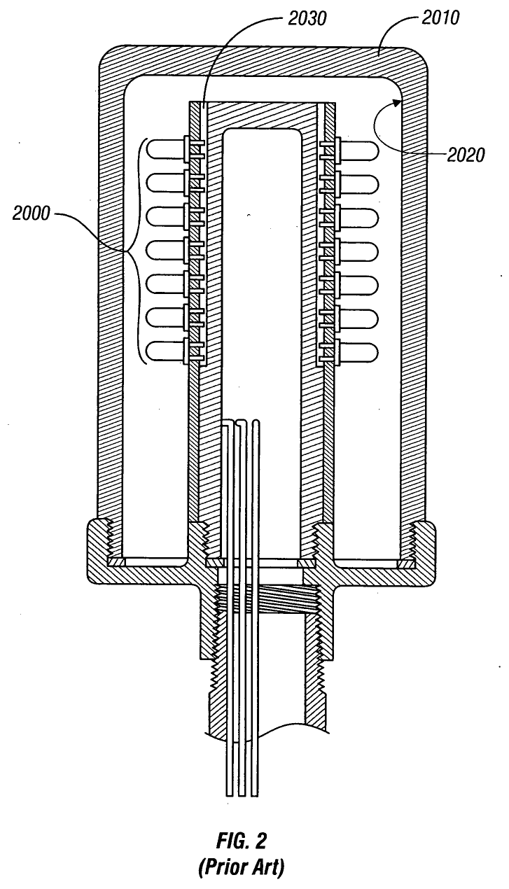

Referring to FIG. 2, an illustrative view of a conventional lighting unit is shown. The lighting unit of FIG. 2 is typically used for navigational beacons and warning lights, and is described in U.S. Pat. No. 5,890,794 to Abtahi et al. The conventional lighting unit shown in FIG. 2 includes a plurality of forward directing LEDs 2000 to generate sufficient light for use as a signaling device. The plurality of LEDs 2000 is comprised of forward directing LEDs mounted sideways on a flexible circuit board assembly 2030 such that the light is emitted generally in a horizontal pattern relative to the device. The plurality of LEDs 2000 is arranged into columns spaced radially around the flexible circuit board assembly 2030. The lighting unit also includes a transparent cover 2010 with an inner surface 2020. The transparent cover 2010 is not a lens, but the inner surface 2020 may be coated, frosted or roughened with sandpaper to diffuse light from the plurality of LEDS over a wide angle. Alternatively, the inner surface 2020 may be made to function similar to a lens by application of a thin transparent sheet having a number of ridges, such that the inner surface refracts light in a manner similar to a Fresnel lens.

However, the lighting unit shown in FIG. 2 lacks an optic or system of optics to increase intensity of the light emitted or enhance the direction of light transmitted by the number of LEDs. The effectiveness of a beacon employing the lighting unit shown in FIG. 2 is thus limited by the lack of optics to focus and increase the intensity of the emitted light. In order to increase the efficiency of the signal since the unit lacks true optics, the lighting unit of FIG. 2 requires significant alteration of the inner surface 2020 during the manufacturing process. The lighting unit also suffers the disadvantage of employing a plurality of forward directing LEDs, such that the light emitted is not already directed along the horizon for the greatest efficiency as a beacon or warning light.

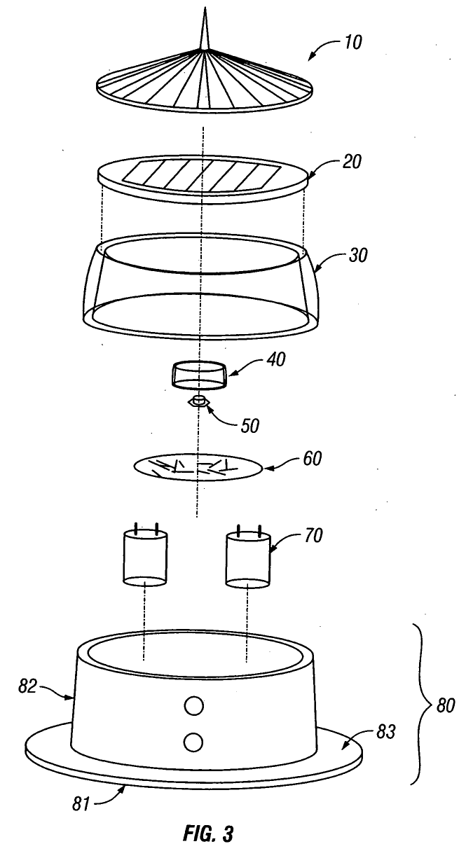

Referring to FIG. 3, an exploded view of one embodiment of the present invention is shown. The signaling device includes a power source 70, either an opaque cover 10 or a photovoltaic top 20, a second optic 30, a first optic 40, and a side-emitting LED 50. The power source 70 may be an external power source or an electrolytic cell or battery of electrolytic cells contained within the signaling device. In one embodiment, the opaque cover 10 is used when the power source 70 is an external power source. When used, the opaque cover 10 is generally colored to match the side-emitting LED 50. In another embodiment, the photovoltaic top 20 is alternatively used when the power source 70 is a storage device, such as an electrolytic cell or battery, instead of an external power source. When used, the photovoltaic top 20 includes photocells and a transparent cover, and replaces the opaque cover 10. A second optic 30 is disposed around a first optic 40. A side-emitting LED 50 is disposed within the first optic 40. The side-emitting LED 50 is connected operably to electronic circuitry 60. The photovoltaic top 20 is also connected electrically to the electronic circuitry 60 and the power source 70. The electronic circuitry 60 is also connected operably to the power source 70, and controls flashing of the side-emitting LED 50. The second optic 30, first optic 40 and the power source 70 are disposed on the base 80.

In the embodiment shown in FIG. 3, the base 80 has a bottom portion 81 and a wall portion 82 extending vertically from the bottom portion 81. The bottom portion 81 extends radially past the wall portion 82, forming a flange 83. However, the presence of a flange is not required. The wall portion 82 of the embodiment of FIG. 3 is cylindrical. The base 80 fulfills the purpose of housing the electric circuitry 60 and the power source 70, and sheltering them from the elements in an outdoor environment. The base 80 also provides a means of mounting the signaling device to a supporting structure in various applications.

It should be understood that the size, shape and configuration of the base 80 might be varied to accommodate various applications. For example, the wall portion 82 may assume a variety of shapes, including a square or rectangular shape. Likewise, the thickness, height and angle of inclination of the wall portion 82, the inner diameter or width of the wall portion 82, and the size, shape, and thickness of the bottom portion 81 may vary depending upon application. For example, the height of the wall portion 82 may range from about 1.5 to 10 inches, most preferably from about 2 to 7 inches. Likewise, the thickness of the wall portion may range from about 0.125 to 0.5 inches, most preferably from about 0.125 to 0.25 inches. The inner diameter or inner width dimension of the wall portion preferably is within the range from 3 to 10 inches, most preferably from about 5 to 7 inches. In addition the width or diameter of the bottom portion 81 preferably is between about 3 and 12 inches, most preferably about 6 to 11 inches. The thickness of the same preferably is between about 0.125 and 0.375 inches. Again, the dimensions are given by way of example, not limitation.

The base 80 may be made of any materials that are suitable for marine or outdoor use. Preferable materials of construction for the base 80 include engineering plastic, non-corrosive metal, polycarbonate plastic or fiber filled composite plastic. Particularly preferred is polycarbonate plastic or fiber filled composite plastic.

In a preferred embodiment, the outer diameter of the bottom portion 81 of the base 80 is 10 inches, its thickness is 0.375 inches and it is made from polycarbonate plastic. Likewise, the wall portion 82 has a height of 6 inches, a thickness of 0.200 inches and an inner diameter of 5 inches. The base 80 is preferably molded as a single part.

The power source 70 provides power for the signaling device. The power source 70 is operably connected to the electronic circuitry 60 and the side-emitting LED 50, and powers the electronic circuitry 60 and the side-emitting LED 50 in a manner that would be readily understood by one skilled in the art. In one embodiment, the power source 70 is also operably connected to the photovoltaic top 20, which allows solar power to recharge the power source 70 when electrolytic cells are used. In one embodiment of the present invention, power source 70 using electrolytic cells with 4 volts (nominal) voltage is typically used. However, electrolytic cells that are not rechargeable by solar power may also be used for the power source 70 and the opaque cover 10 may be employed in place of the photovoltaic top 20. One skilled in the art would understand the variety of electrolytic cells available for use in applications for signaling devices, and would understand the electronic configuration connecting the power source 70, the side-emitting LED 50, the photovoltaic top 20 (when used), and the electronic circuitry 60 powering the side-emitting LED for operation of the signaling device.

The electronic circuitry 60 is operably connected to the side-emitting LED 50 and the power source 70 to power and control the flashing of the side-emitting LED 50 of the present invention. The electronic circuitry 60 may comprise a printed electronic circuit board. The electronic circuitry 60 may also comprise other configurations that are not pre-printed onto a circuit board. One skilled in the art would understand the electronic configuration of circuits and components of the electronic circuitry 60 required to control flashing of the side-emitting LED 50.

The side-emitting LED 50 emits light in a cone pattern 360 degrees horizontally about the side-emitting LED 50. In accordance with one embodiment of the invention, the side-emitting LED 50 used is selected from the group of LEDs sold under the name and trademark Lumileds™ Luxeon Emitter LXHL-Dx01. The Lumileds™ side-emitting LED is offered in red, green, white, cyan, blue and yellow models, all of which may be appropriate for use in the present invention. The side-emitting LED 50 is connected operably to the electronic circuitry 60, which is adapted to control the signal light from the side-emitting LED 50. The light emitted from the side-emitting LED 50 can be controlled to emit light in a steady beam, or any pattern of flashing. The side-emitting LED 50 is a very small light source that emits a relatively narrow band of light over 360 degrees, at an angle of several degrees above the plane of the horizon. LEDs provide a longer lasting light source than an incandescent lamp, thereby reducing failure rate and necessary maintenance. One benefit of implementing a signaling device with a side-emitting LED is that the band of light is more limited to the plane along the horizon, thus the optic more effectively deviates the light downward to center on the horizon, and transmits light more efficiently along the plane of the horizon.

The side-emitting LED 50 is disposed within the first optic 40 and the second optic 30. The side-emitting LED 50 is disposed on and operably connected to the electronic circuitry 60. The operation of an LED device, and more specifically, a side-emitting LED device as connected to a power source and electronic circuitry, is readily known and understood by one skilled in the art.

The first optic 40 functions to partially deviate and focus the light emitted from the LED of the signaling device. As discussed above, the first optic 40 is disposed within the second optic 30. In one embodiment, the operative refractive part of the first optic 40 has an interior surface, which is substantially conical; and the interior surface of the first optic 40 is linear from the top edge to the bottom edge while the exterior surface of the first optic 40 is convex. In yet another embodiment, the first optic 40 is composed of optical-grade polycarbonate with a high refractive index, for example, a refractive index of approximately n=1.586. In another embodiment, the first optic 40 is composed of an acrylic, with a lower refractive index, for example, a refractive index ranging from approximately n=1.48 to 1.50. Other refractive compounds or materials used in manufacturing optics may be used and are known by one skilled in the art. The vertical divergences of red and yellow side-emitting LEDs differ substantially from those for white and green side-emitting LEDs. Therefore, different first optics are used in the various embodiments of the present invention. For different colored side-emitting LEDs, the refraction required is different, and thus the characteristics of the lens for the first optic 40 are based on the side-emitting LED used in the particular embodiment. These various first optics are designed so that the vertical characteristics of the light beam are essentially independent of the color of the side-emitting LED after refraction by the first optic 40. This approach means that the second optic 30 behaves essentially the same for all colors of LED.

The first optic 40 may be manufactured in a variety of sizes and shapes, and from a wide variety of materials commonly used by those skilled in the art for manufacturing optics. Examples of suitable materials include optical-grade acrylic and polycarbonate. There are a number of manufacturing techniques which may be used to manufacture the first optic 40. Preferably, the first optic 40 may be manufactured by injection molding to minimize costs. When manufacturing optics, such as the first optic 40, by injection molding techniques, it is advantageous to design parts to be molded in a two-piece mold considerably lower in cost than a complex three-piece mold. Manufacturing by injection molding with a two-piece mold may be accomplished by design of the first optic 40 such that both optical surfaces have single-directional draft for removal from the mold.

It should be understood that the size, shape and configuration of the first optic 40 may be varied to accommodate various applications. In a particular embodiment, for example, the first optic 40 is cylindrical, the diameter of the first optic 40 is 1 inch, the refractive index of the first optic 40 is 1.586, and the thickness of the first optic 40 is 0.125 inches. Due to material shrinkage during the molding process, it is preferred that the first optic 40 be less than a maximum thickness of about 0.250 inches.

The second optic 30 substantially centers the beam on the horizon and determines the final vertical divergence of the light emitted from the LED of the signaling device. In one embodiment, the operative refractive part of the second optic 30 has an interior surface, which is substantially conical; and the interior surface of the second optic 30 is linear from the top edge to the bottom edge. Depending on the divergence desired for the application, the exterior surface of the second optic 30 may be convex, linear, or concave in various embodiments. In yet another embodiment, the second optic 30 is composed of optical-grade polycarbonate with a high refractive index, for example, a refractive index of approximately n=1.586. In another embodiment, the second optic 30 is composed of an acrylic, with a lower refractive index, for example, a refractive index ranging from approximately n=1.48 to 1.50.

The second optic 30 may be manufactured from a wide variety of materials commonly used by those skilled in the art for manufacturing optics. Examples of suitable materials include optical-grade acrylic and polycarbonate. There are a number of manufacturing techniques which may be used to manufacture the second optic 30. Preferably, the second optic 30 may be manufactured by injection molding to minimize costs. When manufacturing optics such as the second optic 30 by injection molding techniques, it is advantageous to design parts to be molded in a two-piece mold considerably lower in cost than a complex three-piece mold. Manufacturing by injection molding with a two-piece mold may be accomplished by design of the second optic 30 such that both optical surfaces have single-directional draft for removal from the mold.

It should be understood that the size, shape and configuration of the second optic 30 might be varied to accommodate various applications. In a particular embodiment, for example, the second optic 30 is cylindrical, the diameter of the second optic 30 is 8 inches, the refractive index of the second optic 30 is n=1.586, and the thickness of the second optic 30 is 0.125 inches. Due to material shrinkage during the molding process, it is preferred that second optic 30 be less than a maximum thickness 0.250 inches.

Light is emitted from the side-emitting LED 50 through the first optic 40, which partially deviates and focuses the cone of light emitting from the side-emitting LED 50. After passing through the first optic 40, the partially focused light passes through the second optic 30, which centers the beam along the plane of the horizon. The final vertical divergence is the field illuminated by the refracted and focused light emitted from the signaling device. The vertical divergence is determined by several factors, including the color of the side-emitting LED 50; the surface curvature, wedge, and refractive index of the first optic 40; and the surface curvature, wedge, and refractive index of the second optic 30. In addition to centering the beam on the horizon and producing the desired vertical divergence, it is beneficial to produce a light distribution that is symmetric with respect to the horizon.

The photovoltaic top 20 is adapted for charging the electrolytic cells used in the power source 70. In one embodiment, the diameter of the photovoltaic top 20 is approximately 7.5 inches. The size of the photovoltaic top 20 is dictated by the particular application for which the signaling device is intended. The photovoltaic top 20 includes photocells that collect energy from sunlight passing through a transparent cover, as is well known by one skilled in the art. Using solar energy to power a signaling device and recharge electrolytic cells is well known by one skilled in the art.

The opaque cover 10 alternatively used with an external power source is made of an opaque material and is colored to match the LED color. In one embodiment, the opaque cover is made of opaque polycarbonate plastic of a color that is similar to that of the LED light source, chosen for its characteristic of withstanding the elements in an outdoor environment. The size of and shape of the opaque cover is dictated by the size of the optics. In an embodiment, the opaque cover 10 is large enough to cover and enclose the first optic 40 and second optic 30. In a preferred embodiment, the diameter of the opaque cover 10 is approximately 7.5 inches.

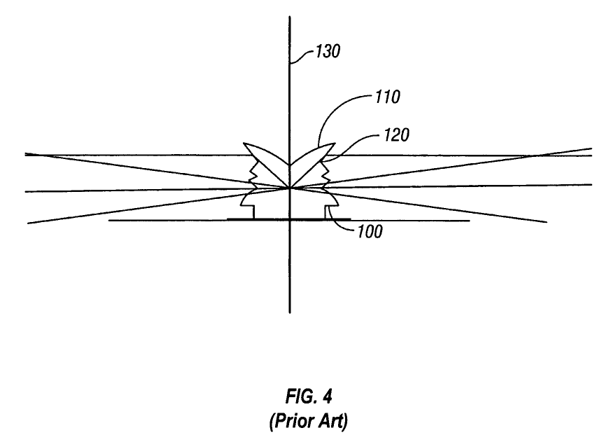

Referring to FIG. 4, an illustrative view of a side-emitting LED package useable with the present invention is shown. An example of one such side-emitting LED is described in U.S. Pat. No. 6,598,998, West et al., assigned to Lumileds Lighting, U.S., LLC., Which is incorporated herein by reference. The figure shows a typical radiation pattern of a side-emitting LED. The lens 100 of the LED includes a refractive portion 120 and a total internal reflection conical portion 110. The refractive portion 120 is designed to refract and bend light so that the light exits from lens 100 as close to perpendicular to the axis running vertically through the center of the LED as possible. The conical portion 110 is designed as a total internal reflection surface that reflects light such that light exits the lens 100 as close to perpendicular to the vertical axis 130 through the center of the LED as possible, rather than emitting light out of the top of the LED in a forward direction as occurs with a conventional LED package.

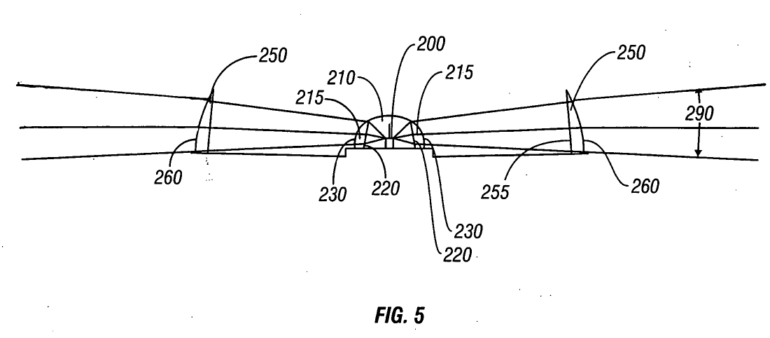

FIG. 5 shows an illustrative view of the refractive process of one embodiment of the present invention. A side-emitting LED 200 is enclosed in a space 210 inside a first optic 215. The first optic 215 is enclosed within a second optic 250. The first optic 215 has an interior surface 220 and an exterior surface 230. The interior surface 220 of the first optic 215 is substantially conical, and exhibits an upwardly converging linear profile. The exterior surface 230 of the first optic 215 is convex. The second optic 250 has an interior surface 255 and an exterior surface 260. The interior surface 255 of the second optic 250 is substantially conical, and exhibits an upwardly converging linear profile. The exterior surface 260 of the second optic 250 may be convex, concave or linear. Light is emitted from the side-emitting LED 200 through the first optic 215, which partially deviates and focuses the cone of light emitted by the side-emitting LED 200. After passing through the first optic 215, the partially focused light passes through the second optic 250, which centers the beam generally along the plane of the horizon and determines the final vertical divergence 290. The vertical divergence 290 determines the field illuminated by the refracted and focused light emitted from the signaling device. The vertical divergence is the degree of divergence from the horizontal axis of the signaling device. The vertical divergence 290 is determined by several factors, including whether the side-emitting LED 200 is red, yellow, green or white; the characteristics such as curvature, wedge, and refractive index of the first optic 215; and the characteristics such as curvature, wedge, and refractive index of the second optic 250.

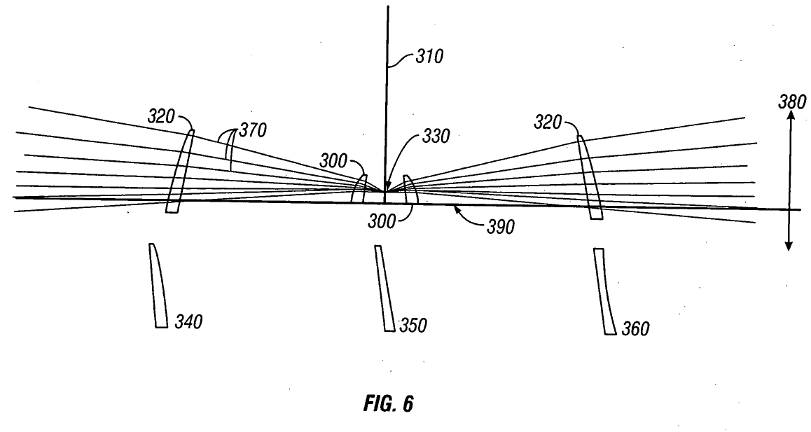

Referring to FIG. 6, an illustrative view of alternative lenses for the compound optic of the present invention is shown. A first optic 300 is shown centered around the center axis 310 and an LED 330. A second optic 320 encloses the first optic 300. The second optic 320 may comprise a convex second optic 340, a linear second optic 350, or a concave second optic 360, depending on the needs of the application. There is a horizontal axis 390 defined as perpendicular to the central axis 310. FIG. 6 illustrates the divergence of light (transmitted through the first optic 300 and the second optic 320) from the horizontal axis 390 of the signaling device.

In operation, beams of light 370 are emitted from a side-emitting LED 330 based on the control signal from electronic circuitry not shown in the figure. The beams of light 370 may be emitted by the side-emitting LED 330 in a steady manner or controlled in any pattern of flashing. The beams of light 370 are transmitted first through the first optic 300, and are deviated vertically toward the horizon 390. The beams of light 370 are then transmitted through the second optic 320. The second optic 320 further deviates the beams of light 370 vertically, providing controlled vertical divergence 380 along the plane of the horizontal axis 390.

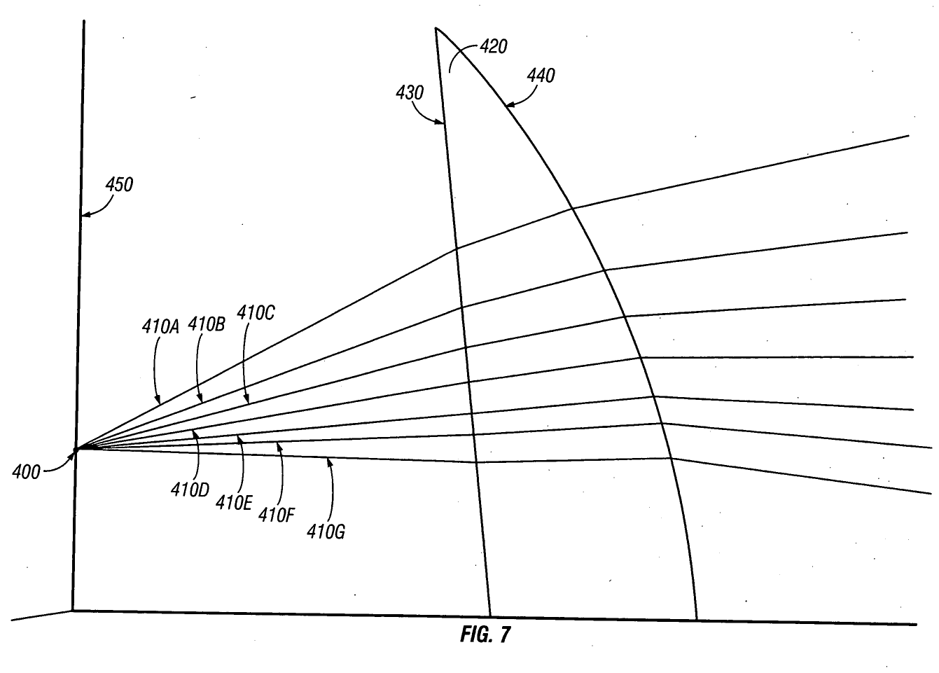

FIG. 7 provides an illustrative view of one embodiment of the present invention employing a green or white side-emitting LED 400 emitting light rays 410A through 410G through a first optic 420. The first optic 420 includes an interior surface 430 and an exterior surface 440. The interior surface 430 is linear and the exterior surface 440 is convex. In operation, a green or white side-emitting LED 400 emits light rays 410A through 410G. In the embodiment shown in FIG. 7, the first optic 420 has a refractive index n=1.586, achieved using optical-grade polycarbonate. As the light rays 410A through 410G pass through the first optic 420, the light rays 410A through 410G are refracted according to the basic laws of optics.

For illustrative purposes, there is also defined a central axis 450 running vertically through the LED 400. In the embodiment shown in FIG. 7, light ray 410A is transmitted across the interior surface 430 of the first optic 420. Before transmittance across the interior surface 430, light ray 410A is approximately 27.770° from the perpendicular to the central axis 450. Then the light ray 410A is transmitted across the exterior surface 440 of the first optic 420. After transmittance across the exterior surface 440, the light ray 410A is approximately 12.347° from the perpendicular to the central axis 450.

Similarly, light ray 410B is transmitted across the interior surface 430 of the first optic 420. Before transmittance across the interior surface 430, light ray 410B is approximately 20.130° from the perpendicular to the central axis 450. Then the light ray 410B is transmitted across the exterior surface 440 of the first optic 420. After transmittance across the exterior surface 440, the light ray 410B is approximately 7.500° from the perpendicular to the central axis 450.

Likewise, light ray 410C is transmitted across the interior surface 430 of the first optic 420. Before transmittance across the interior surface 430, light ray 410C is approximately 14.700° from the perpendicular to the central axis 450. Then the light ray 410C is transmitted across the exterior surface 440 of the first optic 420. After transmittance across the exterior surface 440, the light ray 410C is approximately 3.860° from the perpendicular to the central axis 450.

In a similar fashion, before transmittance across the interior surface 430, light ray 410D is approximately 9.800° from the perpendicular to the central axis 450. After transmittance across the exterior surface 440, the light ray 410D is approximately 0.552° from the perpendicular to the central axis 450. Before transmittance across the interior surface 430, light ray 410E is approximately 5.330° from the perpendicular to the central axis 450. After transmittance across the exterior surface 440, the light ray 410E is approximately 2.460° from the perpendicular to the central axis 450.

Before transmittance across the interior surface 430, light ray 410F is approximately 2.300° from the perpendicular to the central axis 450. After transmittance across the exterior surface 440, the light ray 410F is approximately 4.500° from the perpendicular to the central axis 450. Refracted similarly, before transmittance across the interior surface 430, light ray 410G is approximately 1.60° from the perpendicular to the central axis 450. After transmittance across the exterior surface 440, the light ray 410G is approximately 7.094° from the perpendicular to the central axis 450.

In the embodiment shown in FIG. 7, the final vertical divergence after passing through the first optic 420 is contained to approximately 20°. Specifically, light ray 410A is 4.847° from 410B. Light ray 410B is 3.64° from 410C. Light ray 410C is 3.308° from light ray 410D. Light ray 410D is 3.012° from light ray 410E. Light ray 410E is 2.040° from light ray 410F. Light ray 410F is 2.594° from light ray 410G. The sum of all the angles between light rays equals the final vertical divergence.

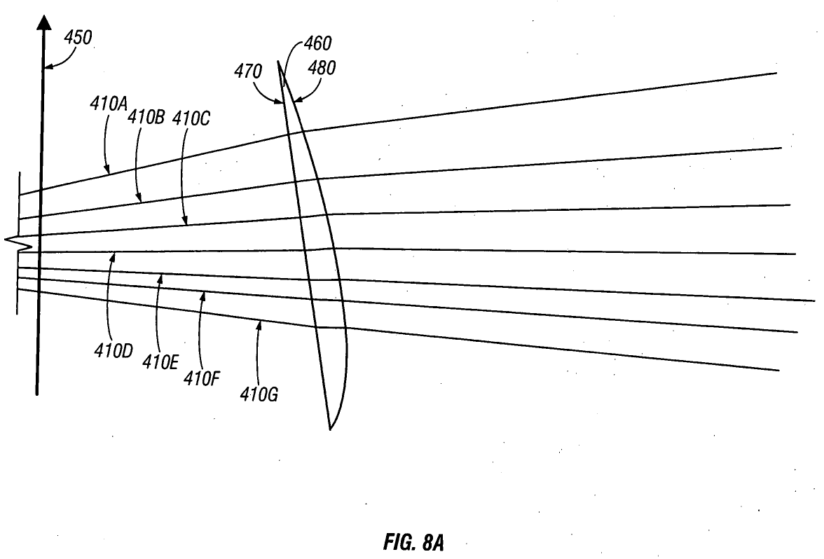

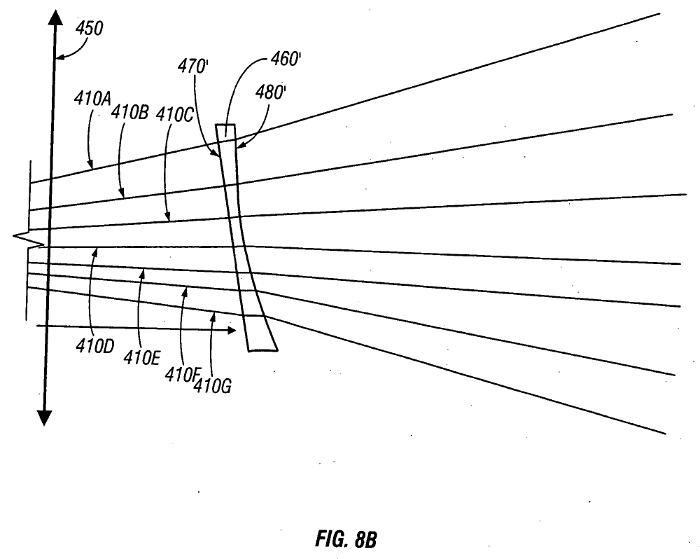

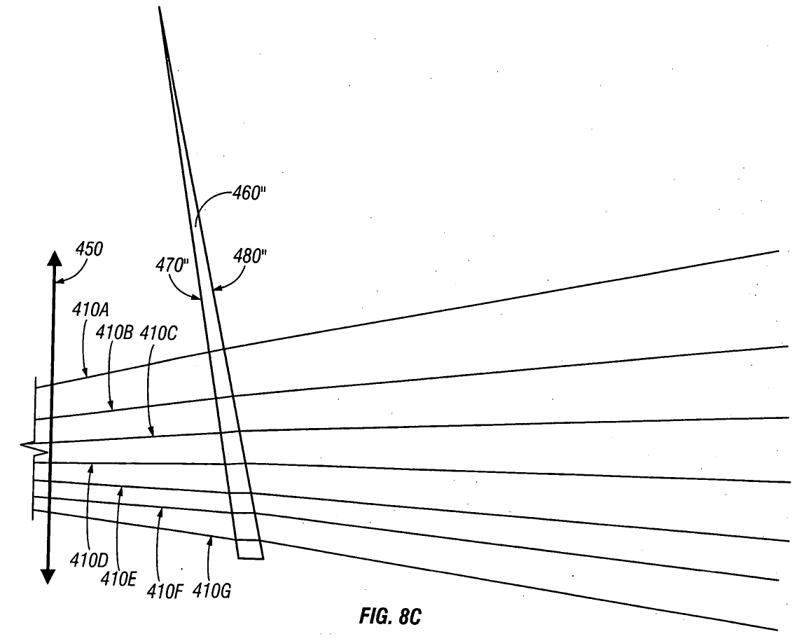

FIG. 8A provides an illustrative view of one embodiment of the second optic 460, and the vertical divergence of light determined by the second optic 460. The second optic 460 includes an interior surface 470 and an exterior surface 480. The interior surface 470 is linear and the exterior surface 480 is convex. In operation, a green or white side-emitting LED 400 emits light rays 410A through 410G. In the embodiment shown in FIG. 8A, the second optic 460 has a refractive index n=1.586, achieved using optical-grade polycarbonate. As the light rays 410A through 410G pass through the second optic 460, the light rays 410A through 410G are refracted according to the basic laws of optics.

For illustrative purposes, there is also defined a central axis 450 as also shown in FIG. 7. In the embodiment shown in FIG. 8A, light ray 410A is transmitted across the interior surface 470 and the exterior surface 480 of the second optic 460. After transmittance across the exterior surface 480, light ray 410A is approximately 6.906° from the perpendicular to the central axis 450.

Similarly refracted, light ray 410B is transmitted across the interior surface 470 and the exterior surface 480 of the second optic 460. After transmittance across the exterior surface 480, light ray 410B is approximately 3.836° from the perpendicular to the central axis 450. Light ray 410C is transmitted across the interior surface 470 and the exterior surface 480 of the second optic 460. After transmittance across the exterior surface 480, light ray 410C is approximately 1.317° from the perpendicular to the central axis 450. Light ray 410D is transmitted across the interior surface 470 and the exterior surface 480 of the second optic 460. After transmittance across the exterior surface 480, light ray 410D is approximately 0.557° from the perpendicular to the central axis 450.

Light ray 410E is transmitted across the interior surface 470 and the exterior surface 480 of the second optic 460. After transmittance across the exterior surface 480, light ray 410E is approximately 2.416° from the perpendicular to the central axis 450. Light ray 410F is transmitted across the interior surface 470 and the exterior surface 480 of the second optic 460. After transmittance across the exterior surface 480, light ray 410F is approximately 3.660° from the perpendicular to the central axis 450. Light ray 410G is transmitted across the interior surface 470 and the exterior surface 480 of the second optic 460. After transmittance across the exterior surface 480, light ray 410G is approximately 5.210° from the perpendicular to the central axis 450.

In the embodiment shown in FIG. 8A, the final vertical divergence after passing through the second optic 460 is contained to less than 15°. Specifically, light ray 410A is 3.070° from 410B. Light ray 410B is 2.519° from 410C. Light ray 410C is 1.874° from light ray 410D. Light ray 410D is 1.859° from light ray 410E. Light ray 410E is 1.244° from light ray 410F. Light ray 410F is 1.550° from light ray 410G. The sum of all the angles between light rays equals the final vertical divergence.

FIG. 8B provides an illustrative view of an alternative embodiment of the second optic 460′, and the vertical divergence of light determined by the second optic 460′. The second optic 460′ includes an interior surface 470′ and an exterior surface 480′. The interior surface 470′ is linear and the exterior surface 480′ is concave. In operation, a green or white side-emitting LED 400 emits light rays 410A through 410G. In the embodiment shown in FIG. 8B, the second optic 460′ has a refractive index n=1.586, achieved using optical-grade polycarbonate. As the light rays 410A through 410G pass through the second optic 460′, the light rays 410A through 410G are refracted according to the basic laws of optics.

For illustrative purposes, there is also defined a central axis 450 as also shown in FIG. 7. In the embodiment shown in FIG. 8B, light ray 410A is transmitted across the interior surface 470′ and the exterior surface 480′ of the second optic 460′. After transmittance across the exterior surface 480′, light ray 410A is approximately 17.275° from the perpendicular to the central axis 450.

Similarly refracted, light ray 410B is transmitted across the interior surface 470′ and the exterior surface 480′ of the second optic 460′. After transmittance across the exterior surface 480′, light ray 410B is approximately 10.032° from the perpendicular to the central axis 450. Light ray 410C is transmitted across the interior surface 470′ and the exterior surface 480′ of the second optic 460′. After transmittance across the exterior surface 480′, light ray 410C is approximately 3.832° from the perpendicular to the central axis 450. Light ray 410D is transmitted across the interior surface 470′ and the exterior surface 480′ of the second optic 460′. After transmittance across the exterior surface 480′, light ray 410D is approximately 1.402° from the perpendicular to the central axis 450.

Light ray 410E is transmitted across the interior surface 470′ and the exterior surface 480′ of the second optic 460′. After transmittance across the exterior surface 480′, light ray 410E is approximately 3.366° from the perpendicular to the central axis 450. Light ray 410F is transmitted across the interior surface 470′ and the exterior surface 480′ of the second optic 460′. After transmittance across the exterior surface 480′, light ray 410F is approximately 9.982° from the perpendicular to the central axis 450. Light ray 410G is transmitted across the interior surface 470′ and the exterior surface 480′ of the second optic 460′. After transmittance across the exterior surface 480′, light ray 410G is approximately 14.906° from the perpendicular to the central axis 450.

Ultimately, the final vertical divergence for the particular embodiment shown in FIG. 8B is spread to more than 25° after passing through the second optic 460′. Specifically, light ray 410A is 7.243° from 410B. Light ray 410B is 6.200° from 410C. Light ray 410C is 5.234° from light ray 410D. Light ray 410D is 1.964° from light ray 410E. Light ray 410E is 6.616° from light ray 410F. Light ray 410F is 4.924° from light ray 410G. The sum of all the angles between light rays equals the final vertical divergence.

FIG. 8C provides an illustrative view of an alternative embodiment of the second optic 460″, and the vertical divergence of light determined by the second optic 460″. The second optic 460″ includes an interior surface 470″ and an exterior surface 480″. The interior surface 470″ is linear and the exterior surface 480″ is linear. In operation, a green or white side-emitting LED 400 emits light rays 410A through 410G. In the embodiment shown in FIG. 8C, the second optic 460″ has a refractive index n=1.586, achieved using optical-grade polycarbonate. As the light rays 410A through 410G pass through the second optic 460″, the light rays 410A through 410G are refracted according to the basic laws of optics.

For illustrative purposes, there is also defined a central axis 450 as also shown in FIG. 7. In the embodiment shown in FIG. 8C, light ray 410A is transmitted across the interior surface 470″ and the exterior surface 480″ of the second optic 460″. After transmittance across the exterior surface 480″, light ray 410A is approximately 10.899° from the perpendicular to the central axis 450.

Similarly refracted, light ray 410B is transmitted across the interior surface 470″ and the exterior surface 480″ of the second optic 460″. After transmittance across the exterior surface 480″, light ray 410B is approximately 6.046° from the perpendicular to the central axis 450. Light ray 410C is transmitted across the interior surface 470″ and the exterior surface 480″ of the second optic 460″. After transmittance across the exterior surface 480″, light ray 410C is approximately 2.390° from the perpendicular to the central axis 450. Light ray 410D is transmitted across the interior surface 470″ and the exterior surface 480″ of the second optic 460″. After transmittance across the exterior surface 480″, light ray 410D is approximately 0.94° from the perpendicular to the central axis 450.

Light ray 410E is transmitted across the interior surface 470″ and the exterior surface 480″ of the second optic 460″. After transmittance across the exterior surface 480″, light ray 410E is approximately 3.98° from the perpendicular to the central axis 450. Light ray 410F is transmitted across the interior surface 470″ and the exterior surface 480″ of the second optic 460″. After transmittance across the exterior surface 480″, light ray 410F is approximately 6.044° from the perpendicular to the central axis 450. Light ray 410G is transmitted across the interior surface 470″ and the exterior surface 480″ of the second optic 460″. After transmittance across the exterior surface 480″, light ray 410G is approximately 8.674° from the perpendicular to the central axis 450.

Ultimately, the final vertical divergence for this particular embodiment is spread to approximately 2° after passing through the second optic 460″. Specifically, light ray 410A is 4.853° from 410B. Light ray 410B is 3.656° from 410C. Light ray 410C is 3.33° from light ray 410D. Light ray 410D is 3.04° from light ray 410E. Light ray 410E is 2.064° from light ray 410F. Light ray 410F is 2.630° from light ray 410G. The sum of all the angles between light rays equals the final vertical divergence.

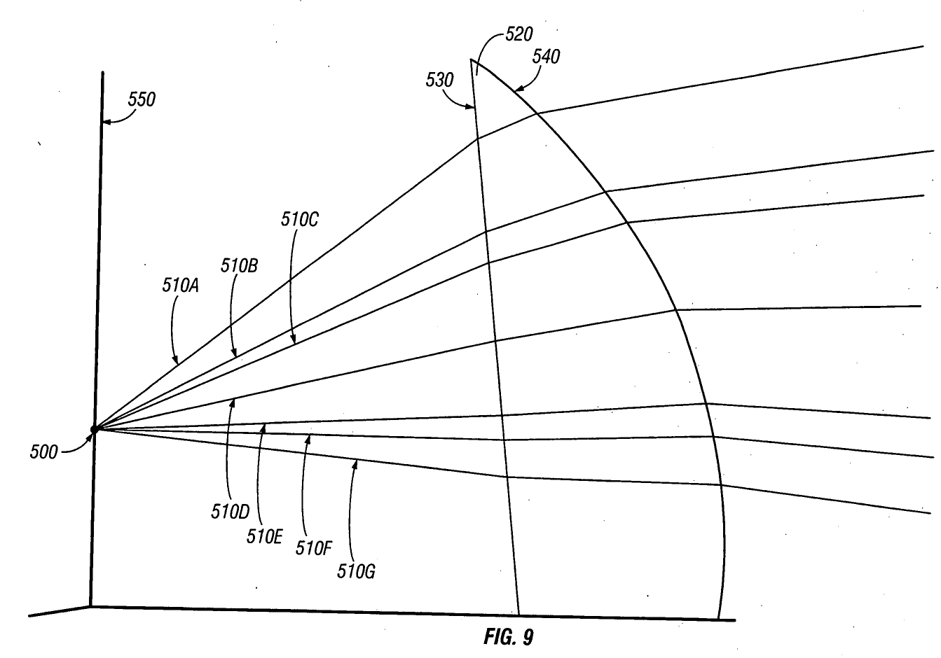

FIG. 9 provides an illustrative view of one embodiment employing a red or yellow side-emitting LED 400 emitting light rays 510A through 510G through a first optic 520 The first optic 520 includes an interior surface 530 and an exterior surface 540. The interior surface 520 is linear and the exterior surface 530 is convex. In operation, a red or yellow side-emitting LED 500 emits light rays 510A through 510G. In the embodiment shown in FIG. 9, the first optic 520 has a refractive index n=1.586, achieved using optical-grade polycarbonate. As the light rays 510A through 510G pass through the first optic 520, the light rays 510A through 510G are refracted according to the basic laws of optics.

For illustrative purposes, there is also defined a central axis 550 running vertically through the side-emitting LED 500. In the embodiment shown in FIG. 9, light ray 510A is transmitted across the interior surface 530 of the first optic 520. Before transmittance across the interior surface 530, light ray 510A is approximately 37.700° from the perpendicular to the central axis 550. Then the light ray 510A is transmitted across the exterior surface 540 of the first optic 520. After transmittance across the exterior surface 540, the light ray 510A is approximately 10.320° from the perpendicular to the central axis 550.

Similarly, light ray 510B is transmitted across the interior surface 530 of the first optic 520. Before transmittance across the interior surface 530, light ray 510B is approximately 27.430° from the perpendicular to the central axis 550. Then the light ray 510B is transmitted across the exterior surface 540 of the first optic 520. After transmittance across the exterior surface 540, the light ray 510B is approximately 7.50° from the perpendicular to the central axis 550.

Likewise, light ray 510C is transmitted across the interior surface 530 of the first optic 520. Before transmittance across the interior surface 530, light ray 510C is approximately 23.47° from the perpendicular to the central axis 550. Then the light ray 510C is transmitted across the exterior surface 540 of the first optic 520. After transmittance across the exterior surface 540, the light ray 510C is approximately 6.023° from the perpendicular to the central axis 550.

In a similar fashion, before transmittance across the interior surface 530, light ray 510D is approximately 13.020° from the perpendicular to the central axis 550. After transmittance-across the exterior surface 540, the light ray 510D is approximately 1.681° from the perpendicular to the central axis 550. Before transmittance across the interior surface 530, light ray 510E is approximately 2.570° from the perpendicular to the central axis 550. After transmittance across the exterior surface 540, the light ray 510E is approximately 2:886° from the perpendicular to the central axis 550.

Before transmittance across the interior surface 530, light ray 510F is approximately 6.900° from the perpendicular to the central axis 550. After transmittance across the exterior surface 540, the light ray 510F is approximately 4.50° from the perpendicular to the central axis 550. Refracted similarly, before transmittance across the interior surface 530, light ray 510G is approximately 5.900° from the perpendicular to the central axis 550. After transmittance across the exterior surface 540, the light ray 510G is approximately 6.670° from the perpendicular to the central axis 550.

In the embodiment shown in FIG. 9, the final vertical divergence after passing through the first optic 520 is contained to approximately 20°. Specifically, light ray 510A is 2.820° from 510B. Light ray 510B is 1.477° from 510C. Light ray 510C is 4.342° from light ray 510D. Light ray 510D is 4.567° from light ray 510E. Light ray 510E is 1.614° from light ray 510F. Light ray 510F is 2.17° from light ray 510G. The sum of all the angles between light rays equals the final vertical divergence.

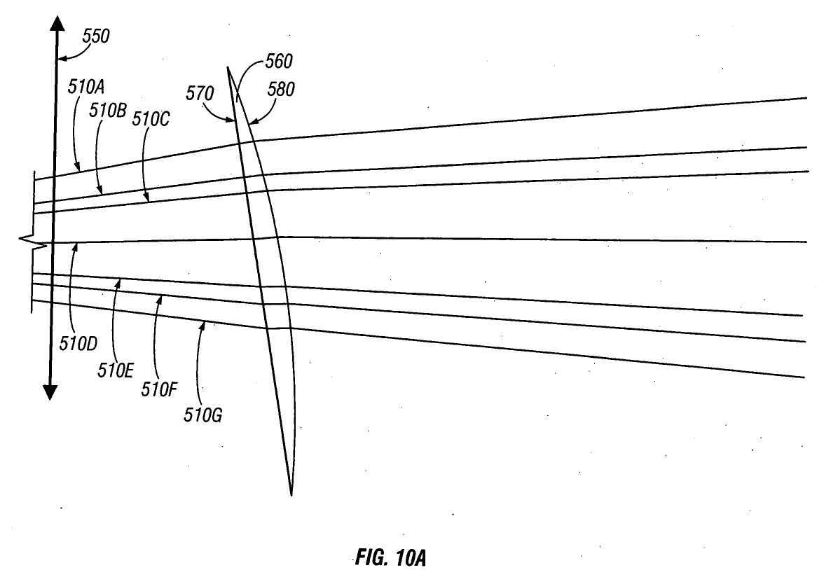

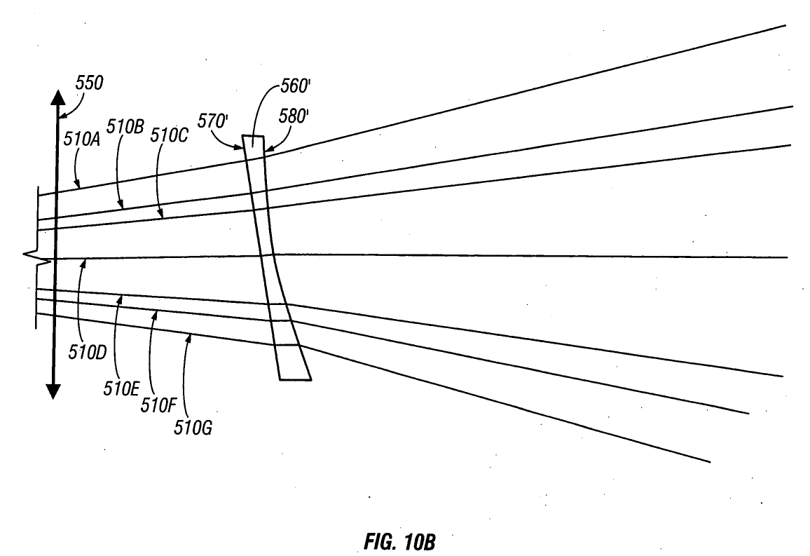

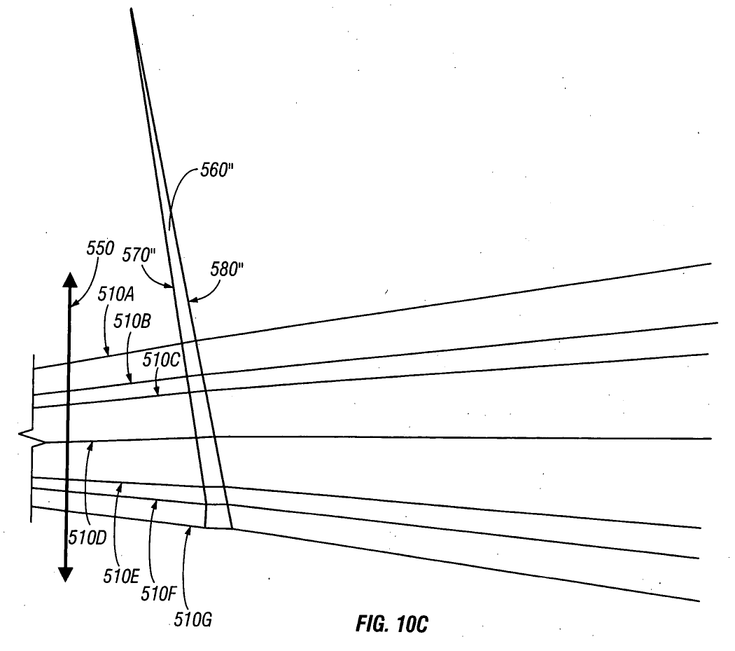

FIG. 10A provides an illustrative view of one embodiment of the second optic 560, and the vertical divergence of light determined by the second optic 560. The second optic 560 includes an interior surface 570 and an exterior surface 580. The interior surface 570 is linear and the exterior surface 580 is convex. In operation, a red or yellow side-emitting LED 500 emits light rays 510A through 510G. In the embodiment shown in FIG. 10A, the second optic 560 has a refractive index n=1.586, achieved using optical-grade polycarbonate. As the light rays 510A through 510G pass through the second optic 560, the light rays 510A through 510G are refracted according to the basic laws of optics.

For illustrative purposes, there is also defined a central axis 550 as also shown in FIG. 7A. In the embodiment shown in FIG. 10A, light ray 510A is transmitted across the interior surface 570 and the exterior surface 580 of the second optic 560. After transmittance across the exterior surface 580, light ray 510A is approximately 5.044° from the perpendicular to the central axis 550.

Similarly refracted, light ray 510B is transmitted across the interior surface 570 and the exterior surface 580 of the second optic 560. After transmittance across the exterior surface 580, light ray 510B is approximately 3.521° from the perpendicular to the central axis 550. Light ray 510C is transmitted across the interior surface 570 and the exterior surface 580 of the second optic 560. After transmittance across the exterior surface 580, light ray 510C is approximately 2.660° from the perpendicular to the central axis 550. Light ray 510D is transmitted across the interior surface 570 and the exterior surface 580 of the second optic 560. After transmittance across the exterior surface 580, light ray 510D is approximately 0.084° from the perpendicular to the central axis 550.

Light ray 510E is transmitted across the interior surface 570 and the exterior surface 580 of the second optic 560. After transmittance across the exterior surface 580, light ray 510E is approximately 2.571° from the perpendicular to the central axis 550. Light ray 510F is transmitted across the interior surface 570 and the exterior surface 580 of the second optic 560. After transmittance across the exterior surface 580, light ray 510F is approximately 3.500° from the perpendicular to the central axis 550. Light ray 510G is transmitted across the interior surface 570 and the exterior surface 580 of the second optic 560. After transmittance across the exterior surface 580, light ray 510G is approximately 4.766° from the perpendicular to the central axis 550.

The final vertical divergence for this particular embodiment is contained to less than approximately 1° after passing through the second optic 560. Specifically, light ray 510A is 1.523° from 510B. Light ray 510B is 0.861° from 510C. Light ray 510C is 2.576° from light ray 510D. Light ray 510D is 2.655° from light ray 510E. Light ray 510E is 0.929° from light ray 510F. Light ray 510F is 1.266° from light ray 510G. The sum of all the angles between light rays equals the final vertical divergence.

FIG. 10B provides an illustrative view of an alternative embodiment of the second optic 560′, and the vertical divergence of light determined by the second optic 560′. The second optic 560′ includes an interior surface 570′ and an exterior surface 580′. The interior surface 570′ is linear and the exterior surface 580′ is concave. In operation, a red or yellow side-emitting LED 500 emits light rays 510A through 510G. In the embodiment shown in FIG. 10B, the second optic 560′ has a refractive index n=1.586, achieved using optical-grade polycarbonate. As the light rays 510A through 510G pass through the second optic 560′, the light rays 510A through 510G are refracted according to the basic laws of optics.

For illustrative purposes, there is also defined a central axis 550 as also shown in FIG. 7. In the embodiment shown in FIG. 10B, light ray 510A is transmitted across the interior surface 570′ and the exterior surface 580′ of the second optic 560′. After transmittance across the exterior surface 580′, light ray 510A is approximately 14.891° from the perpendicular to the central axis 550.

Similarly refracted, light ray 510B is transmitted across the interior surface 570′ and the exterior surface 580′ of the second optic 560′. After transmittance across the exterior surface 580′, light ray 510B is approximately 10.00° from the perpendicular to the central axis 550. Light ray 510C is transmitted across the interior surface 570′ and the exterior surface 580′ of the second optic 560′. After transmittance across the exterior surface 580′, light ray 510C is approximately 7.600° from the perpendicular to the central axis 550. Light ray 510D is transmitted across the interior surface 570′ and the exterior surface 580′ of the second optic 560′. After transmittance across the exterior surface 580, light ray 510D is approximately 0.487° from the perpendicular to the central axis 550.

Light ray 510E is transmitted across the interior surface 570′ and the exterior surface 580′ of the second optic 560′. After transmittance across the exterior surface 580′, light ray 510E is approximately 7.342° from the perpendicular to the central axis 550. Light ray 510F is transmitted across the interior surface 570′ and the exterior surface 580′ of the second optic 560′. After transmittance across the exterior surface 580′, light ray 510F is approximately 10.299° from the perpendicular to the central axis 550. Light ray 510G is transmitted across the interior surface 570′ and the exterior surface 580′ of the second optic 560′. After transmittance across the exterior surface 580′, light ray 510G is approximately ˜14.712° from the perpendicular to the central axis 550.

Ultimately, the final vertical divergence for this particular embodiment is spread to more than 25° after passing through the second optic 560′. Specifically, light ray 510A is 4.891° from 510B. Light ray 510B is 2.400° from 510C. Light ray 510C is 7.113° from light ray 510D. Light ray 510D is 7.829° from light ray 510E. Light ray 510E is 2.957° from light ray 510F. Light ray 510F is 4.413° from light ray 510G. The sum of all the angles between light rays equals the final vertical divergence.

FIG. 10C provides an illustrative view of an alternative embodiment of the second optic 560″, and the vertical divergence of light determined by the second optic 560″. The second optic 560″ includes an interior surface 570″ and an exterior surface 580″. The interior surface 570″ is linear and the exterior surface 580″ is linear. In operation, a red or yellow side-emitting LED 500 emits light rays 510A through 510G. In the embodiment shown in FIG. 10C, the second optic 560″ has a refractive index n=1.586, achieved using optical-grade polycarbonate. As the light rays 510A through 510G pass through the second optic 560″, the light rays 510A through 510G are refracted according to the basic laws of optics.

For illustrative purposes, there is also defined a central axis 550 as also shown in FIG. 7. In the embodiment shown in FIG. 10C, light ray 510A is transmitted across the interior surface 570″ and the exterior surface 580″ of the second optic 560″. After transmittance across the exterior surface 580″, light ray 510A is approximately 8.872° from the perpendicular to the central axis 550.

Similarly refracted, light ray 510B is transmitted across the interior surface 570″ and the exterior surface 580″ of the second optic 560″. After transmittance across the exterior surface 580″, light ray 510B is approximately 6.046° from the perpendicular to the central axis 550. Light ray 510C is transmitted across the interior surface 570″ and the exterior surface 580″ of the second optic 560″. After transmittance across the exterior surface 580″, light ray 510C is approximately 4.565° from the perpendicular to the central axis 550. Light ray 510D is transmitted across the interior surface 570″ and the exterior surface 580″ of the second optic 560″. After transmittance across the exterior surface 580″, light ray 510D is approximately 0.198° from the perpendicular to the central axis 550.

Light ray 510E is transmitted across the interior surface 570″ and the exterior surface 580″ of the second optic 560″. After transmittance across the exterior surface 580″, light ray 510E is approximately 4.441° from the perpendicular to the central axis 550. Light ray 510F is transmitted across the interior surface 570″ and the exterior surface 580″ of the second optic 560″. After transmittance across the exterior surface 580″, light ray 510F is approximately 6.044° from the perpendicular to the central axis 550. Light ray 510G is transmitted across the interior surface 570″ and the exterior surface 580″ of the second optic 560″. After transmittance across the exterior surface 580″, light ray 510G is approximately 8.3090 from the perpendicular to the central axis 550.

The final vertical divergence for this particular embodiment is spread to approximately 17° after passing through the second optic 560″. Specifically, light ray 510A is 2.826° from 510B, Light ray 510B is 1.481° from 510C. Light ray 510C is 4.367° from light ray 510D. Light ray 510D is 4.639° from light ray 510E. Light ray 510E is 1.603° from light ray 510F. Light ray 510F is 2.265° from light ray 510G. The sum of all the angles between light rays equals the final vertical divergence.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A signaling device, comprising:
a power source;
electronic circuitry connected to said power source;
a side-emitting LED for emitting light, said LED operably connected to said electronic circuitry;
a first optic disposed around said side-emitting LED;
a second optic disposed around said first optic; and
said first and second optic focusing said light.

2. The signaling device of claim 1, wherein said second optic has a concave outer surface.

3. The signaling device of claim 1, wherein said second optic has a convex outer surface.

4. The signaling device of claim 1, wherein said second optic has a linear conical outer surface.

5. The signaling device of claim 1, wherein said side-emitting LED is a single diode.

6. The signaling device of claim 1, wherein said electronic circuitry connected to said power source is adapted to control a pattern of said light.

7. The signaling device of claim 1, wherein said light is refracted by said first optic and transmitted to said second optic.

8. The signaling device of claim 1, wherein said light is refracted by said second optic after refraction by said first optic.

9. The signaling device of claim 1, wherein said power source comprises:
one or more electrolytic cells; and
a photovoltaic top for providing charge to said electrolytic cells.

10. The signaling device of claim 9, wherein said photovoltaic top is comprised of photocells and a transparent cover.

11. The signaling device of claim 9, wherein said photovoltaic top covers said second optic.

12. The signaling device of claim 1, wherein said power source comprises:
an external source of power; and
an opaque top.

13. The signaling device of claim 1, wherein said first optic is composed of acrylic or optical-grade polycarbonate.

14. The signaling device of claim 1, wherein said second optic is composed of acrylic or optical-grade polycarbonate.

15. The signaling device of claim 1, wherein said signaling device is adapted for use on a marine buoy.

16. The signaling device of claim 1, wherein said signaling device is adapted for use as a marine signal.

17. The signaling device of claim 1, wherein said first optic and said second optic refract said light such that said signaling device emits approximately 80% of said light within a range of 20° off the plane of the horizon.

18. A signaling device, comprising:
a power source;
electronic circuitry connected to said power source;
a side-emitting LED for emitting light, said LED operably connected to said electronic circuitry;
a first optic disposed around said side-emitting LED;
a second optic disposed around said first optic; and
said signaling device having a horizontal axis roughly perpendicular to said side-emitting LED;
wherein said side-emitting LED emits approximately 80% of said light within about 2° off said horizontal axis.

19. The signaling device of claim 18, wherein said second optic has a concave outer surface.

20. The signaling device of claim 18, wherein said second optic has a convex outer surface.

21. The signaling device of claim 18, wherein said second optic has a linear conical outer surface.

22. The signaling device of claim 18, wherein said electronic circuitry is adapted to control a pattern of said light.

23. The signaling device of claim 18, wherein said light is refracted by said first optic to said second optic.

24. The signaling device of claim 18, wherein said power source comprises:
one or more electrolytic cells; and
a photovoltaic top for providing charge to said electrolytic cells.

25. The signaling device of claim 24, wherein said photovoltaic top is comprised of photocells and a transparent cover.

26. The signaling device of claim 24, wherein said photovoltaic top covers said second optic.

27. The signaling device of claim 18, wherein said power source comprises:
an external source of power; and
an opaque top.

28. The signaling device of claim 18, wherein said first optic and said second optic refract said light such that said signaling device emits approximately 80% of said light within a range of 2° off of said horizontal axis.

29. A signaling device, comprising:
a power source comprising one or more electrolytic cells;
a side-emitting LED for emitting light, said LED operably connected to said electronic circuitry;
electronic circuitry adapted to control a pattern of said light;
a first optic disposed around said side-emitting LED;
a second optic disposed around said first optic;
said signaling device having a horizontal axis roughly perpendicular to said side-emitting LED; and
a photovoltaic top, said photovoltaic top connected operably to said power source for providing charge, said photovoltaic top comprising of photocells and a transparent or translucent cover;
wherein said side-emitting LED emits approximately 80% of said light within about 20° off of said horizontal axis.

30. A method for focusing light in a signaling device, comprising the steps of:
providing a side-emitting LED, powered by a power source, and an optics system, said optics system including a first optic and a second optic;
emitting light from said side-emitting LED;
passing said light through said first optic;
passing said light from said first optic to said second optic; and
passing said light through said second optic;
wherein said light passing through said second optic results in being substantially parallel to the horizon.

31. A method of claim 30, wherein said second optic determines final vertical divergence of said light.

32. An optics system for use in a signaling device, comprising:
a side-emitting LED for emitting light;
a first optic disposed around said side-emitting LED;
a second optic disposed around said first optic;
wherein said first optic and said second optic cooperatively focus said light emitted from said side-emitting LED along the horizon.

33. The optics system of claim 32, wherein said second optic has a concave outer surface.

34. The optics system of claim 32, wherein said second optic has a convex outer surface.

35. The optics system of claim 32, wherein said second optic has a linear conical outer surface.

36. The optics system of claim 32, wherein said light emitted from said side-emitting LED is refracted by said first optic to said second optic.

37. The optics system of claim 33 32, wherein said first optic and said second optic refract said light from said side-emitting LED such that said signaling device emits approximately 80% of emitted light within a range of 20° off the plane of the horizon.

38. A signaling device, comprising:
a power source;
electronic circuitry connected to said power source;
a side-emitting LED for emitting light, said LED operably connected to said electronic circuitry;
a first optic disposed around said side-emitting LED, said first optic having:
an interior surface having a geometry selected from the group consisting of substantially conical, concave, convex, and linear; and,
an exterior surface having a geometry selected from the group consisting of substantially conical, concave, convex, and linear;
a second optic disposed around said first optic, said first optic having:
an interior surface having a geometry selected from the group consisting of substantially conical, concave, convex, and linear; and,
an exterior surface having a geometry selected from the group consisting of substantially conical, concave, convex, and linear,
said first and second optic focusing said light.

39. A signaling device, comprising:
a power source;
electronic circuitry connected to said power source;
a side-emitting LED for emitting light, said LED operably connected to said electronic circuitry;
a first lens disposed around said side-emitting LED;
a second lens disposed around said first lens; and
said first and second lens focusing said light.

40. A signaling device, comprising:
a power source;
electronic circuitry connected to said power source;
a side-emitting LED for emitting light, said LED operably connected to said electronic circuitry;
a first lens disposed around said side-emitting LED said first lens having:
an interior surface having a geometry selected from the group consisting of substantially conical, concave, convex, and linear; and,
a second lens disposed around said first lens, said first lens having:
an interior surface having a geometry selected from the group consisting of substantially conical, concave, convex, and linear; and, and
said first and second lens focusing said light.

41. A method of projecting light 180° about a horizontal plane comprising the steps of:
generating a stream of light with a light source,
passing said light through a first optic, said first optic disposed around said light source, to form a first modified stream of light, said first modified stream of light refracted a finite angle from the perpendicular to the central axis running vertically through the light source,
passing said first modified stream of light through a second optic, said second optic disposed around said first optic, to form a second modified stream of light said first modified stream of light refracted a finite angle from the perpendicular to the central axis running vertically through the light source.

42. The method of claim 41, wherein one or both of said first optic and said second optic are lenses.

43. The method of claim 41, wherein said light source is a side-emitting LED.
